(19) United States
(12) Patent Application Publication
(10) Pub. No.: US 2026/0171712 A1
(43) Pub. Date: Jun. 18, 2026

(54) HIGH-PERFORMANCE CONNECTOR WITH DETACHABLE CONTACT SECURING MEANS

(71) Applicant: HARTING Electric Stiftung & Co. KG, Espelkamp (DE)

(72) Inventors: Norbert Kropiewnicki, Espelkamp (DE); Nando Hoppe, Espelkamp (DE)

(21) Appl. No.: 19/124,806

(22) PCT Filed: Oct. 25, 2023
(86) PCT No.: PCT/DE2023/100792

§ 371 Date: Apr. 25, 2025

(30) Foreign Application Priority Data
Nov. 7, 2022 (DE) 10 2022 129 331.9

(51) Int. Cl. H01R 13/53; H01R 13/187; H01R 13/426

(52) U.S. Cl. CPC H01R 13/53; H01R 13/187; H01R 13/426

(57) ABSTRACT

A high-performance connector for receiving at least one electrical cable has a contact holder for fixing a contact element connected to the cable in place in an insulating body, wherein the contact holder has an at least essentially hollow-cylindrical main body on which at least two contact arms are arranged, and wherein the contact arms are configured to form, starting from the main body, a diameter which decreases in a direction away from the main body.

### BACKGROUND OF THE INVENTION

The invention takes as its starting-point a high-performance connector according to the type defined in the independent claim, claim 1.

High-performance connectors of such a type are needed in order to transmit and/or distribute high electrical voltages and/or high electric currents. In this regard, particular attention is paid to their applicability in underfloor regions of rail-bound vehicles, in particular to the connection of railcars and wagons to one another. A further field of application is to be found in the field of the generation and/or transmission of electricity, particularly in the field of photovoltaic installations and/or wind power plants.

CN 11934122 A presents a high-performance connector for a high-performance-connector system, in particular for use in the field of application constituted by rail vehicles.

Further solutions are known in the prior art that enable the transmission and/or distribution of high electric currents and/or voltage. Some of these solutions, however, are obsolete and have barely been updated/modernized.

A particularly disadvantageous aspect of the prior art is a comparatively complex assembly procedure. This complexity complicates the repair and/or maintenance of high-performance connectors unnecessarily.

### SUMMARY OF THE INVENTION

The object of the invention consists in offering a high-performance connector that is easy to assemble and maintain.

The high-performance connector according to the invention has been designed to receive at least one electrical cable. The high-performance connector exhibits an at least one-piece housing and an at least one-piece insulating body for receiving an electrical contact element. The contact element has been brought into electrically conducting communication with the cable. Furthermore, the high-performance connector exhibits a contact mounting for fixing the contact element in the insulating body. In addition, the high-performance connector exhibits a cable fixing for secure arrangement of the cable on the housing. The contact mounting exhibits an at least basically hollow cylindrical base body on which at least two contact arms are arranged. Proceeding from the base body, and tapered from the base body, the contact arms have been realized in protruding manner in the plug-in direction, and the contact mounting is brought into communication with the housing in tool-free manner and reversibly. High-performance connectors of such a type are also designated as single-pole connectors. The high-performance connector has been designed primarily to transmit a high electric current intensity and/or a high electrical voltage to a cable-terminal housing or to a mating connector. By “high electric current intensity”, a current intensity of over 100 amperes is meant. In particular, a current intensity of over 500 amperes is meant. Quite particularly, a current intensity of over 800 amperes is meant. A current intensity greater than or equal to 1000 amperes is also conceivable. By the term “high electrical voltage”, a voltage of over 1 kilovolt is to be understood. In particular, a voltage of over 10 kilovolts is meant. Quite particularly, a voltage of over 15 kilovolts is meant. A voltage greater than or equal to 25 kilovolts is also conceivable. By virtue of the connection of a high-performance connector to the terminal region, in accordance with the invention a media-tight sealing of the interior space is created at the appropriate point. For this purpose, the housing of the high-performance connector has been shaped in such a manner that the housing engages with a basically congruently formed terminal region. For improved sealing, both said high-performance connector and/or the terminal region of the cable-terminal housing or mating connector have been provided with a gasket. By the term “contact mounting”, a fixing element is meant that is inserted into the insulating body and/or into the housing, in order to hold the contact element in the insulating body in position at the stipulated point. The taper of the contact arms arranged on the contact mounting ensures that the contact element can be inserted into the insulating body in the plug-in direction from the direction of the cable fixing, usually realized as a cable gland. A flange and/or stop on the contact element, arranged peripherally, is firstly utilized in order to displace the contact arms elastically outward. When the desired position is reached, the contact arms spring back elastically behind the stop of the contact element, and fix this stop. In order to be able to take the contact element out of the high-performance connector in the case of repair and/or maintenance, the contact mounting can be removed from the stipulated position in tool-free manner. In this case, “tool-free” preferably means that the contact mounting can be taken out of the insulating body and/or out of the housing entirely by hand. Alternatively, removal of the contact mounting without a special tool is conceivable. The use of a blade, a flat-head screwdriver or similar aids is nevertheless conceivable. The contact mounting may have been manufactured from a dielectric material. Under certain circumstances, however, the use of electrically conducting materials may also be contemplated. For this purpose, the housing should have been manufactured from an adequate material, in order not to incur any safety risks. In certain cases, a plastic housing is conceivable and expedient. The housing is preferably manufactured from a metallic material. In contrast to the housing, the contact mounting is preferably manufactured from a synthetic material.

In a version that has been developed further, the contact arms exhibit a substantially curvilinear taper, with the curvature increasing, proceeding from the base body. This version makes a certain elastic resilience possible, even in the case of comparatively rigid base materials.

A further embodiment provides that the contact arms of the contact mounting are separated from one another by recesses, the contact arms and the recesses being arranged peripherally in alternating manner. By this, it is meant that each contact arm is separated from each further contact arm by a recess in each direction of rotation. Particularly in the case of comparatively inflexible or inelastic materials, in this way an advantageous flexibility is obtained which is expedient for the purpose of inserting the contact element.

An ingenious embodiment provides that the width of the contact arms decreases from the base body to the end of the contact arms. By virtue of this structural adaptation, material is saved, particularly in the case of large numbers of units, as a result of which a more cost-effective and nevertheless high-performance contact mounting can be offered.

One embodiment provides that the width of the recesses is greater than or equal to the width of the contact arms. This comparatively simple adaptation guarantees a basically sufficient retaining force of the contact arms, with sufficient space for elastic deformation of the contact arms.

A particularly advantageous embodiment provides that at least one housing arm is arranged peripherally on the base body of the contact mounting. By virtue of such a housing arm, a reversible process of engagement can be implemented particularly advantageously. The housing arm is ideally provided with detent means which enter into interaction with corresponding detent means of the housing and/or of the insulating body. For this purpose, the housing arm may protrude beyond the base body of the contact mounting. As a result, the housing arm can be easily released from the engagement with the housing and/or with the insulating body without the use of special aids. A housing arm that can be actuated manually is particularly preferred.

In a space-saving embodiment, the housing arm is arranged within the base body and is separated from the base body by two peripheral recesses. By this, it is meant that the housing arm may be a separate, or delimited, part of the base body, which by virtue of the flanking recesses can be realized to be elastically deformable. Consequently, the housing arm can easily be resiliently arranged on the base body and/or in the base body and may have been configured in such a manner that the contact mounting is brought into engagement with the insulating body and/or with the housing in interlocking manner.

Furthermore, one embodiment provides that the housing arm exhibits a recess which has been designed to receive a retaining shape, the retaining shape being arranged within the insulating body and/or within the housing. In addition, it is proposed that the recess within the housing arm is at least partly surrounded by a reinforcing element.

An alternative embodiment provides that the housing arm exhibits a retaining shape which is brought into engagement with a recess, the recess being arranged within the insulating body and/or within the housing.

A particularly preferred embodiment provides that the contact mounting exhibits at least four contact arms and at least two housing arms. In tests, this embodiment has proved particularly reliable as regards retaining force and also ease of assembly.

A further embodiment provides that in the connected state in the housing and/or in the insulating body the housing arms are released from the state of connection to the housing and/or to the insulating body by application of a force in order to remove a contact element from the housing and/or from the insulating body.

A further embodiment provides that the force for releasing the connected state of the contact mounting and the housing and/or the insulating body is directed substantially inward, in the direction of the longitudinal axis of the contact mounting.

An alternative embodiment provides that the force for releasing the connected state of the contact mounting and the housing and/or the insulating body is directed substantially outward, in the direction of the housing of the high-performance connector.

### BRIEF DESCRIPTION OF THE DRAWINGS

An example of an embodiment of the invention is represented in the drawings and will be elucidated in more detail in the following.

FIG. 1 shows a schematic representation of a high-performance connector according to the invention in longitudinal section;

FIG. 2 shows a perspective representation of a contact mounting according to the invention;

FIG. 3 shows a view of a contact mounting according to the invention with focus on a housing arm.

Some of the figures contain simplified, schematic representations. In part, identical reference symbols are used for like but possibly not identical elements. Various views of like elements might have been scaled differently. Directional indications such as, for instance, “left”, “right”, “up” and “down” are to be understood with reference to the respective figure, and may vary in the individual representations in comparison with the object represented.

### DETAILED DESCRIPTION OF THE INVENTION

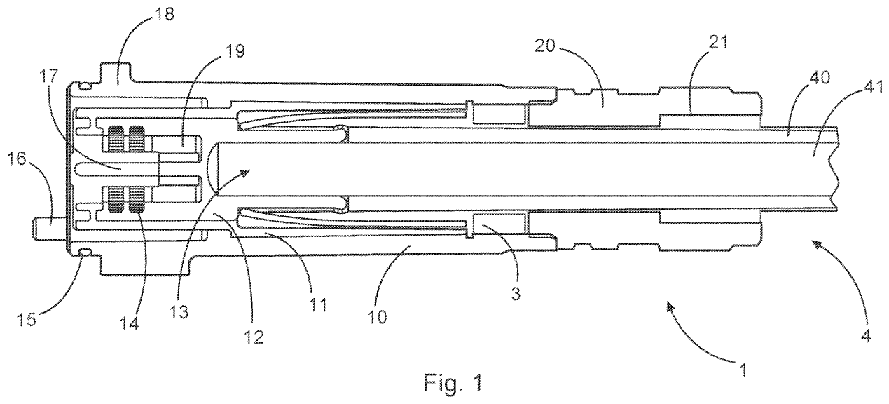

FIG. 1 shows a high-performance connector 1 according to the invention in a representation in longitudinal section. The high-performance connector 1 exhibits, firstly, a housing 10. The housing 10 has preferably been realized from a metallic material. An alternative version of the housing 10 consisting of a synthetic material has been provided. An insulating body 11 is inserted into the housing 10. The insulating body 11 has been shaped to receive a contact element 12. On the cable side, the contact element 12 exhibits a crimp inlet 13, that is to say, an opening for inserting a stripped cable 4, the contact element 12 being pressed, or crimped, onto the conductor 41 of the cable 4. On the plug-in side, the contact element 12 is provided with at least one contact reinforcement 14. For the purpose of improving the electrical contact, contact reinforcements 14 in the form of resilient beryllium tapes and/or so-called Bal Seal springs are often employed in the field of high-performance connectors 1. For the purpose of sealing the housing 10 with respect to a mating connector (not shown) or a terminal housing (not shown), the high-performance connector 1 possesses a gasket element 15 on the plug-in side. An O-ring containing rubber, or an appropriately flexible elastic alternative, is frequently employed here. On the plug-in side, the housing 10 further exhibits at least one coding element 16. The coding element 16 may have been realized as a variable coding element. The coding element 16 can accordingly be inserted at various positions on the plug-in face, in order to prevent an incorrect and/or unintentional connection from being established in the case where several high-performance connectors 1 are employed. The contact element 12 exhibits a further insulating element 17 on the plug-in side. The insulating element 17 may have been slipped on, pressed on, cast on, or attached by injection molding. The housing 10 exhibits a housing stop 18 which prevents a high-performance connector 1 from being brought further than specified into engagement with a terminal housing and/or mating connector. The contact element 12 exhibits a contact inlet 19 on the plug-in side. A contact of a terminal housing and/or mating connector is inserted into this contact inlet 19, so that an electrically conducting connection is established. As mentioned previously, this connection is improved through the use of contact reinforcements 14. On the cable side, the housing 10 terminates with a cable fixing 20. Cable fixings 20 of such a type are usually realized as cable glands. For the purpose of protection against foreign media such as dust and/or fluids, the cable fixing 20 is provided with a cable gasket 21. The cable gasket 21 is pressed by the cable fixing 20 onto the insulation 40 of the cable 4.

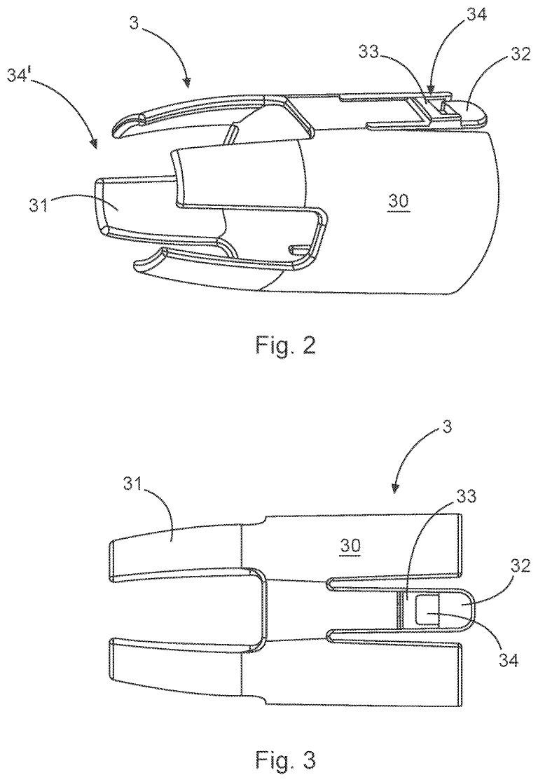

FIG. 2 shows a contact mounting 3 according to the invention in a perspective view. The contact mounting 3 has been constructed on a substantially hollow cylindrical base body 30. On the plug-in side, the base body 30 exhibits contact arms 31 which have been formed extending inward from the base body 30 in the direction of the longitudinal axis of the base body 30. By this means, the plug-in end of the contact mounting 3 is tapered in such a manner that a contact element 12 can be passed through the contact mounting 3 on the cable side. As soon as the contact element 12 has passed through the plug-in end of the contact arms 31, the latter spring back into their original position and prevent the removal or the unintentional release of the contact element 12. The contact arms 31 are flanked peripherally by a recess 34′in each direction of rotation. In the region of the base body 30, a housing arm 32 can further be discerned. The housing arm 32 exhibits a recess 34 which, for instance, is capable of being brought into engagement with a detent element, for instance a detent hook or a detent lug, of an insulating body 11 and/or of the housing 10. The housing arm 32 is flanked laterally by recesses. In this way, the housing arm 32 may have been realized as part of the base body 30. In order to be secured better against forces, in particular during a procedure for plugging in the high-performance connector 1, a reinforcing element 33 has been arranged on the housing arm 32. The contact element 12 is held in position by the contact arms 31, the contact arms 31 absorbing a force contrary to the plug-in direction. The force acting on the contact mounting is transmitted through the recess 34 to a detent element in the housing 10 and/or in the insulating body 11. A reinforcing element 33, arranged at least contrary to the vector of the plug-in force, around the recess 34 is suitable, particularly in an embodiment with a recess 34 for bringing into engagement with a detent shape. Alternatively, the reinforcing element 33 may also have been arranged around the recess 34.

FIG. 3 shows a top view of the housing arm 32 within the base body 30. An expedient configuration of the housing arm 32, which, flanked by recesses, has been inserted within the base body 30, is shown clearly here. An expedient configuration of the contact arms 31 also becomes clear. The reinforcing element 33 is located pointing in the plug-in direction and can accordingly better absorb a force that is transmitted to the housing arm 32 by a detent shape.

### List of Reference Symbols

1 high-performance connector
10 housing
11 insulating body
12 contact element
13 crimp inlet
14 contact reinforcement
15 gasket element
16 coding element
17 insulating element
18 housing stop
19 contact inlet
20 cable fixing
21 cable gasket
3 contact mounting
30 base body
31 contact arm
32 housing arm
33 reinforcing element
34 recess
4 cable
40 insulation
41 conductor

1. A high-performance connector for receiving at least one electrical cable, exhibiting an at least one-piece housing, an at least one-piece insulating body for receiving an electrical contact element, which has been brought into electrically conducting communication with the cable, a contact mounting for fixing the contact element in the insulating body, and a cable fixing for secure arrangement of the cable on the housing, wherein
the contact mounting comprises an at least basically hollow cylindrical base body on which at least two contact arms are arranged, the spacing of the contact arms from the longitudinal axis decreasing in the plug-in direction, proceeding from the base body, and the contact mounting being brought into communication with the housing in tool-free manner and reversibly.

2. The high-performance connector as claimed in claim 1, wherein
the contact arms have a substantially curvilinear taper, with the curvature increasing, proceeding from the base body.

3. The high-performance connector as claimed in claim 1, wherein
the contact arms of the contact mounting are separated from one another by recesses, the contact arms and the recesses being arranged peripherally in alternating manner.

4. The high-performance connector as claimed in claim 1, wherein one
the width of the contact arms decreases in the plug-in direction, proceeding from the base body.

5. The high-performance connector as claimed in claim 1, wherein
the width of the recesses is greater than or equal to the width of the contact arms.

6. The high-performance connector as claimed in claim 1, wherein
at least one housing arm is arranged peripherally on the base body of the contact mounting.

7. The high-performance connector as claimed in claim 1, wherein
the housing arm is arranged within the base body and is separated from the base body by two peripheral recesses.

8. The high-performance connector as claimed in claim 1, wherein
the housing arm has a recess which is configured to receive a retaining shape, the retaining shape being arranged within the insulating body and/or within the housing.

9. The high-performance connector as claimed in claim 1, wherein the recess within the housing arm is at least partly surrounded by a reinforcing element.

10. The high-performance connector as claimed in claim 1, wherein
the housing arm has a retaining shape which is brought into engagement with a recess, the recess being arranged within the insulating body and/or within the housing.

11. The high-performance connector as claimed in claim 1, wherein
the housing arm is resiliently arranged on the base body and/or in the base body and is configured in such a manner that the contact mounting is brought into engagement with the insulating body and/or with the housing in interlocking manner.

12. The high-performance connector as claimed in claim 1, wherein
the contact mounting has at least four contact arms and at least two housing arms.

13. The high-performance connector as claimed in claim 1, wherein
in the state of connection to the housing and/or to the insulating body the contact arms allow a contact element to be inserted in the plug-in direction, and fix the contact element in a plugged-in state by virtue of the taper.

14. The high-performance connector as claimed in claim 1, wherein
in the connected state in the housing and/or in the insulating body the housing arms are released from the state of connection to the housing and/or to the insulating body by application of a force in order to remove a contact element from the housing and/or from the insulating body.

15. The high-performance connector as claimed in claim 1, wherein
the force for releasing the connected state of the contact mounting and the housing and/or the insulating body is directed substantially inward, in the direction of the longitudinal axis of the contact mounting.

16. The high-performance connector as claimed in claim 1, wherein
the force for releasing the connected state of the contact mounting and the housing and/or the insulating body is directed substantially outward, in the direction of the housing of the high-performance connector.

17. The high-performance connector as claimed in claim 2, wherein
the contact arms of the contact mounting are separated from one another by recesses, the contact arms and the recesses being arranged peripherally in alternating manner.

18. The high-performance connector as claimed in claim 2, wherein
the width of the contact arms decreases in the plug-in direction, proceeding from the base body.

19. The high-performance connector as claimed in claim 2, wherein
the width of the recesses is greater than or equal to the width of the contact arms.

20. The high-performance connector as claimed in claim 2, wherein
at least one housing arm is arranged peripherally on the base body of the contact mounting.
